(19) United States
(12) Patent Application Publication
(10) Pub. No.: US 2016/0094462 A1
(43) Pub. Date: Mar. 31, 2016

(54) METHOD AND APPARATUS FOR DYNAMICALLY ADJUSTING RETRANSMISSION TIMING IN A TRANSPORT LAYER

(71) Applicant: TELEFONAKTIEBOLAGET L M ERICSSON (PUBL), Stockholm (SE)

(72) Inventors: Jakob Heitz, Santa Clara, CA (US); Charu Jain, Pleasanton, CA (US); Chuan He, San Jose, CA (US)

(21) Appl. No.: 14/799,248

(22) Filed: Jul. 14, 2015

Related U.S. Application Data
(60) Provisional application No. 62/056,356, filed on Sep. 26, 2014.

(51) Int. Cl. H04L 12/851; H04L 1/18; H04L 29/06

(52) U.S. Cl. CPC H04L 47/24; H04L 69/28; H04L 1/188; H04L 69/16

(57) ABSTRACT

A system and method for dynamically (re)configuring a retransmission timeout (RTO) parameter for a transport protocol in a network element. In one embodiment, in an interval of data transmission, a determination is made for setting an RTO threshold for a next interval based on a plurality of transmission acknowledgement times returned from a receiver in the current interval. Thereafter, RTO thresholds for subsequent intervals are successively (re)adjusted based on a previous interval's measurements of transmission acknowledgement times until the data transmission is completed.

### PRIORITY AND REFERENCE TO RELATED APPLICATION(S)

This nonprovisional application claims priority based upon the following prior United States provisional patent application(s) entitled: (i) “METHOD AND APPARATUS FOR PROVIDING A TRANSMISSION CONTROL PROTOCOL MINIMUM RETRANSMISSION TIMER,” Application No. 62/056,356, filed Sep. 26, 2014, in the name(s) of Jakob Heitz, Charu Jain and Chuan He; and discloses subject matter related to the subject matter of the following commonly owned U.S. patent application(s): (i) “METHOD AND APPARATUS FOR PROVIDING A TRANSMISSION CONTROL PROTOCOL MINIMUM RETRANSMISSION TIMER,” application Ser. No. 14/061,259, filed Oct. 23, 2013, published as U.S. Patent Publication No.: 2015/0012792. Each of the foregoing provisional and/or nonprovisional patent applications is hereby incorporated by reference herein.

### FIELD OF THE DISCLOSURE

The present disclosure generally relates to the field of networks. More particularly, and not by way of any limitation, the present disclosure is directed to a method and apparatus for dynamically adjusting retransmission timing in a transport layer.

### BACKGROUND

In communications networks, a transport layer provides end-to-end or host-to-host communication services for applications within a layered architecture of network components and protocols. Typically, a transport layer may be architected to provide services such as connection-oriented data stream support, reliability, flow control, multiplexing, etc. In the Open System Interconnection (OSI) model of network communications, the transport layer is most often referred to as Layer 4 or L4.

One of the best-known transport protocols is the Transmission Control Protocol (TCP). Other transport protocols comprise the Stream Control Transport Protocol (SCTP), the Datagram Congestion Control Protocol (DCCP), etc.

In general, where a reliable, flow control based transport protocol is implemented in a communications network, it is desirable that there are no spurious retransmissions of data messages between transmitters and receivers disposed in the communications network, especially where the transport protocol uses an estimate of transmission acknowledgement time to infer when to retransmit.

Without limitation, deficiencies in current technologies are exemplified below in a TCP transmission scenario where a TCP connection operating in an environment of highly variable round trip times (RTTs) may be susceptible to many spurious retransmissions.

RFC 6298 describes a methodology for a current retransmission timeout (RTO). In order to compute the current RTO, a TCP sender maintains two state variables, smoothed round trip time (SRTT) and round trip time variation (RTTVAR). Section 2.4 of RFC 6298 states that whenever RTO, e.g., retransmit timer, is computed, if less than 1 second, the RTO should be rounded up to 1 second.

The requirement to round up to 1 second has the undesirable effect of causing a sending device running TCP to wait longer to retransmit than needed as most RTTs are less than 100 milliseconds. For example, a ping from a home in Santa Clara, Calif. to a server in Boston, Mass. can be around 92 mS. In another example, a ping from Santa Clara, Calif. to distant Perth, Australia can be around 325 mS.

TCP code that runs in a virtual machine (VM) environment or in a thread in user-space outside of a kernel may experience several hundred milliseconds in which the TCP code does not run. One example of why the TCP code may not run is because the central processing unit (CPU) is busy running other threads. During the time that the code does run, RTTs may all be a few milliseconds. When the code gets another slice of runtime, some of the RTT measurements may be much longer. Several RTT measurements during the period of optimal thread runtime may cause the RTT estimator to estimate a short RTT. When the kernel swaps the TCP thread out and begins to run a different thread, sessions that have a TCP packet in transit will experience a retransmission after the TCP thread is swapped back in again.

Any RTT estimator that considers short RTTs in its calculation may cause spurious retransmissions in this running environment. This occurs because there are many more short RTTs than long ones and, typically, the long RTTs are much longer than the short RTTs.

Other methodologies for determining RTT typically reduce the RTT estimate for every low RTT sample recorded. Some techniques give higher weight to high samples than low ones, e.g., the Peak-Hopper-RTO algorithm. However, the Peak-Hopper-RTO technique does not adequately address the spurious retransmission problem for a TCP running in a thread. Still further techniques use exponential smoothing algorithms to calculate RTO. However, smoothing algorithms do not work well in bursty or stochastic environments.

### SUMMARY

The present patent disclosure is broadly directed to a scheme for dynamically (re)configuring a retransmission timeout (RTO) parameter for a transport protocol in a network element. In one embodiment, in an interval of data transmission, a determination is made for setting an RTO threshold for a next interval based on a plurality of transmission acknowledgement times returned from a receiver in the current interval. Thereafter, RTO thresholds for subsequent intervals are successively (re)adjusted based on a previous interval's measurements of transmission acknowledgement times until the data transmission is completed.

In another aspect, an embodiment of a method for reducing spurious retransmissions in a TCP environment is disclosed. The claimed embodiment comprises, inter alia, setting an initial RTO for an initial measurement period of data transmission on a connection using TCP. A select number of RTT measurements are measured or otherwise obtained during the initial measurement period of data transmission. A maximum of the select number of RTT measurements obtained in the initial measurement period is determined so as to set an RTO for an interval of data transmission following the initial measurement period. During the interval, a maximum of all RTT measurements obtained in the interval is determined, which is used for resetting a next interval's RTO based on the maximum of the RTT measurements. The process continues to reset RTO values on an interval-by-interval basis responsive to RTT measurements taken in a prior interval until data transmission is complete, wherein the intervals have a configurable boundary and the initial measurement period of data transmission is configured to be shorter than a length of the intervals following the initial measurement period.

In another aspect, an embodiment of an apparatus for reducing spurious retransmissions in a TCP environment is disclosed wherein the apparatus comprises a processor configured to perform one or more methods set forth herein upon execution of suitable program instructions.

In a still further aspect, an embodiment of a non-transitory computer-readable medium containing instructions stored thereon is disclosed for performing one or more embodiments of the methods set forth herein upon execution on a VM or a non-VM platform.

Benefits of the present invention include, but not limited to, a reduction of spurious retransmissions in a network environment that may experience highly variable RTT values. As the RTO threshold values are dynamically (re)adjusted over the course of a data transmission session rather than being set to a fixed “floor” value required in RFC 6298, disclosed embodiments are particularly advantageous in a VM implementation exhibiting bursty behavior. Further features of the various embodiments are as claimed in the dependent claims. Additional benefits and advantages of the embodiments will be apparent in view of the following description and accompanying Figures.

### BRIEF DESCRIPTION OF THE DRAWINGS

Embodiments of the present disclosure are illustrated by way of example, and not by way of limitation, in the Figures of the accompanying drawings in which like references indicate similar elements. It should be noted that different references to “an” or “one” embodiment in this disclosure are not necessarily to the same embodiment, and such references may mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

The accompanying drawings are incorporated into and form a part of the specification to illustrate one or more exemplary embodiments of the present disclosure. Various advantages and features of the disclosure will be understood from the following Detailed Description taken in connection with the appended claims and with reference to the attached drawing Figures in which:

FIG. 1 depicts an example network or connection wherein a transport layer's retransmission timeout (RTO) mechanism between a sender and a receiver may be dynamically adjusted according to an embodiment of the present patent application;

FIG. 2 depicts a flowchart of an embodiment of a dynamic RTO (re)adjustment process;

FIG. 3 illustrates an example message flow diagram showing an RTO period according to an embodiment;

FIG. 4 illustrates an example message flow diagram showing an RTO period according to another embodiment;

FIG. 5 depicts a flowchart of a method for reducing spurious retransmissions in a TCP environment according to an embodiment;

FIG. 6 depicts a flowchart of a method for reducing spurious retransmissions in a TCP environment according to another embodiment;

FIG. 7 illustrates a graph showing RTT measurements during an initial measurement period followed by a plurality of data transmission intervals wherein an RTO parameter is dynamically adjusted according to an example embodiment; and

FIG. 8 depicts a block diagram of an example node having a dynamic RTO adjustment mechanism according to an embodiment of the present patent disclosure.

### DETAILED DESCRIPTION OF THE DRAWINGS

In the following description, numerous specific details are set forth with respect to one or more embodiments of the present patent disclosure. However, it should be understood that one or more embodiments may be practiced without such specific details. In other instances, well-known circuits, subsystems, components, structures and techniques have not been shown in detail in order not to obscure the understanding of the example embodiments. Accordingly, it will be appreciated by one skilled in the art that one or more embodiments of the present disclosure may be practiced without such specific components-based details. It should be further recognized that those of ordinary skill in the art, with the aid of the Detailed Description set forth herein and taking reference to the accompanying drawings, will be able to make and use one or more embodiments without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Additionally, terms such as “coupled” and “connected,” along with their derivatives, may be used in the following description, claims, or both. It should be understood that these terms are not necessarily intended as synonyms for each other. “Coupled” may be used to indicate that two or more elements, which may or may not be in direct physical or electrical contact with each other, co-operate or interact with each other. “Connected” may be used to indicate the establishment of communication, i.e., a communicative relationship, between two or more elements that are coupled with each other. Further, in one or more example embodiments set forth herein, generally speaking, an element, component or module may be configured to perform a function if the element is capable of performing or otherwise structurally arranged to perform that function.

As used herein, a network element or node (e.g., a router, switch, bridge, etc.) is a piece of networking equipment, including hardware and software that communicatively interconnects other equipment on a network (e.g., other network elements, end stations, etc.). Some network elements may comprise “multiple services network elements” that provide support for multiple networking functions (e.g., routing, bridging, switching, Layer-2 aggregation, session border control, Quality of Service, and/or subscriber management, and the like), and/or provide support for multiple application services (e.g., data, voice, and video). Subscriber end stations (e.g., servers, workstations, laptops, notebooks, palm tops, mobile phones, smartphones, multimedia phones, Voice Over Internet Protocol (VOIP) phones, user equipment, terminals, portable media players, GPS units, gaming systems, set-top boxes) may access or consume content/services provided over a packet-switched wide area public network such as the Internet via suitable service provider access networks. Subscriber end stations may also access or consume content/services provided on virtual private networks (VPNs) overlaid on (e.g., tunneled through) the Internet. Whereas some network nodes or elements may be disposed in wired communication networks, others may be disposed in wireless infrastructures. Further, it should be appreciated that example network nodes may be deployed at various hierarchical levels of an end-to-end network architecture.

In an example communication network, content and/or services are typically provided by one or more end stations (e.g., server end stations) belonging to a service or content provider or end stations participating in a peer to peer service, and may include, for example, public webpages (e.g., free content, store fronts, search services), private webpages (e.g., username/password accessed webpages providing email services), and/or corporate networks over VPNs. Typically, subscriber end stations are coupled (e.g., through customer premise equipment coupled to an access network (wired or wirelessly)) to edge network elements, which are coupled (e.g., through one or more core network elements) to other edge network elements, which are coupled to other end stations (e.g., server end stations or elements). Accordingly, an end station for purposes of the present disclosure may be a network server node or a subscriber end station that may be configured to communicate with other end stations using a suitable transport layer architecture for facilitating a variety of communications. An end-to-end transport layer communication link may therefore exist between two server nodes or elements, between two end user devices, or between a server node and an end user device, and may comprise a wireline and/or wireless connection within a private network, a public network, etc., and may span across one or more network domains.

One or more embodiments of the present patent disclosure may be implemented using different combinations of software, firmware, and/or hardware. Thus, one or more of the techniques shown in the Figures (e.g., flowcharts) may be implemented using code and data stored and executed on one or more electronic devices (e.g., an end station, a network element, etc.). Such electronic devices may store and communicate (internally and/or with other electronic devices over a network) code and data using computer-readable media, such as non-transitory computer-readable storage media (e.g., magnetic disks, optical disks, random access memory, read-only memory, flash memory devices, phase-change memory, etc.), transitory computer-readable transmission media (e.g., electrical, optical, acoustical or other form of propagated signals—such as carrier waves, infrared signals, digital signals), etc. In addition, such electronic devices may typically include a set of one or more processors coupled to one or more other components, such as one or more storage devices (non-transitory machine-readable storage media), user input/output devices (e.g., a keyboard, a touch screen, a pointing device, and/or a display), and network connections. The coupling of the set of processors and other components may be typically through one or more buses and bridges (also termed as bus controllers), arranged in any known (e.g., symmetric/shared multiprocessing) or heretofore unknown architectures. Thus, the storage device or component of a given electronic device may be configured to store code and/or data for execution on one or more processors of that electronic device for purposes of implementing one or more techniques of the present disclosure.

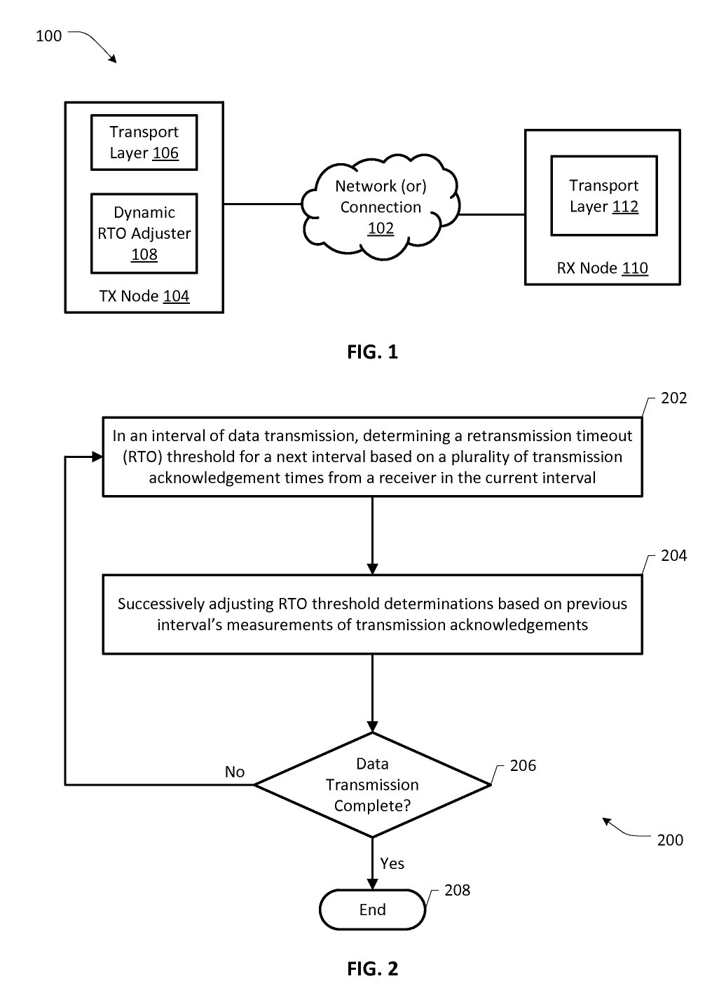

As pointed out elsewhere, communications within a network (e.g., a telecommunications network, a data communications network, or a combination thereof) may be effectuated using a set of appropriate protocols in a layered architecture wherein a transport layer provides end-to-end or host-to-host communication services for applications. To improve reliability, among others, a transport layer protocol may be provided with a retransmission mechanism wherein a sender or transmitter may use a timer threshold that determines when to retransmit a message. That is, if a transmission acknowledgement for a transmitted message is not received within the threshold, the sender may infer that the message has not been successfully received by the receiver and may therefore retransmit that message. Turning now to FIG. 1, depicted therein is an arrangement 100 showing an example end-to-end network or connection 102 wherein a transport layer's retransmission timeout (RTO) mechanism between a sender 104 and a receiver 110 may be dynamically adjusted or readjusted during a data transmission process according to an embodiment of the present patent application. As will be seen below, such a dynamic RTO adjustment process is operative to reduce spurious retransmissions of messages in a variety of transport layer environments that may use receipt of transmission acknowledgements to trigger retransmission, such as, e.g., TCP, SCTP, etc.

Sender 104 is illustrative of a transmitter end station (i.e., Tx node) provided with a suitable transport layer engine 106 (i.e., Layer 4 engine) that may be executed on a virtual or non-virtual machine platform having appropriate hardware and software resources. In a further variation, transport layer engine 106 may be executed as a user-space thread outside an operating system's kernel. In similar fashion, receiver 110 is illustrative of a recipient end station (i.e., Rx node) having a corresponding transport layer engine 112 executing thereon. As noted earlier, the end-to-end network connection 102 may be effectuated via any combination of wireline and/or wireless media using applicable technologies and may span any variable distance. Communications between sender 104 and receiver 110 may comprise any type of communications, e.g., data, voice, and/or multimedia as well as any control messaging pertaining thereto.

In accordance with the teachings herein, a dynamic RTO adjuster 108 is operative in conjunction with transport layer engine 106 disposed at sender 104 wherein an RTO threshold may be updated during a data transmission session based on monitoring the times when message transmission acknowledgements are received by the sender. In other words, as messages (comprising data packets, bytes, frames, protocol data units, etc., for instance) are transmitted by sender 104 to receiver 110, round trip times (RTTs) for receiving corresponding acknowledgements are noted and used in (re)setting the RTO threshold parameter over the course of the data transmission. One skilled in the art will recognize that the determination/decision logic as to when an RTO threshold parameter should be updated or how many RTT measurements need to be used for updating the RTO threshold may be implementation-specific, depending on design goals for achieving a balance between an acceptable level of spurious retransmissions and computational resources. FIG. 2 depicts a flowchart of an embodiment of a dynamic RTO (re)adjustment process 200 for updating a RTO threshold parameter in a transport layer environment. A data transmission session between a sender and a receiver may be configured or otherwise construed as a series of data transmission intervals or periods wherein a plurality of RTT measurements (i.e., transmission acknowledgement times returned from the receiver) obtained in one interval may be used to (re)set the RTO threshold for a future interval (e.g., next interval) of data transmission (block 202). Accordingly, once an RTO threshold for an initial interval has been set up by some mechanism, RTO thresholds for subsequent intervals may be successively (re)adjusted thereafter based on previous intervals' measurements of transmission acknowledgement times (block 204). Such an adjustment process may take place in an iterative manner, for example, as long as data is being transmitted (blocks 206, 208).

In one embodiment, a maximum of all RTTs obtained in a particular data transmission interval may be determined and applied as an RTO threshold for the next interval, which is indicated by the following relationship:

RTO[T+1]=Max{RTT[T]ᵢ},i=1,2, . . . ,N,

where N=the number of RTT measurements obtained during the data transmission interval T. It should be appreciated that although RTTs from the immediate prior data transmission interval may be utilized for determining and/or (re)setting of the RTO of a current interval in the embodiment shown in FIG. 2, a number of variations may be implemented within the scope of the teachings herein. For example, RTT measurements from a sliding window of past {k} data transmission intervals may be utilized in determining an RTO for a current interval, wherein RTTs from different data transmission intervals may potentially be accorded variable weights in one illustrative embodiment. Also, instead of using a Max function, numerous statistical/mathematical formulations involving the measured RTTs may also be implemented for determining or (re)setting an RTO threshold parameter in certain embodiments, including taking into account other packet traffic data metrics. In still further embodiments, boundaries of individual data transmission intervals may be configurable, whereby data transmission intervals of variable sizes (e.g., amounts of data bytes transmitted) or lengths (e.g., on a temporal scale of the data transmission process) may be employed. The foregoing teachings and other variations will be set forth below in additional detail by taking reference to a TCP environment as a non-limiting illustrative example.

It should be appreciated that an environment where the high spikes in RTT measurements are an order of magnitude higher than the regular measurements and the number of high spikes are an order of magnitude less, any RTO estimator that reduces its estimate as a response to receiving an RTT measurement may cause a spurious retransmit when the spike occurs. Such an environment may be seen, for example, when TCP is operating in a thread in a performance-stressed network node configured to provide Layer 4 router functionality.

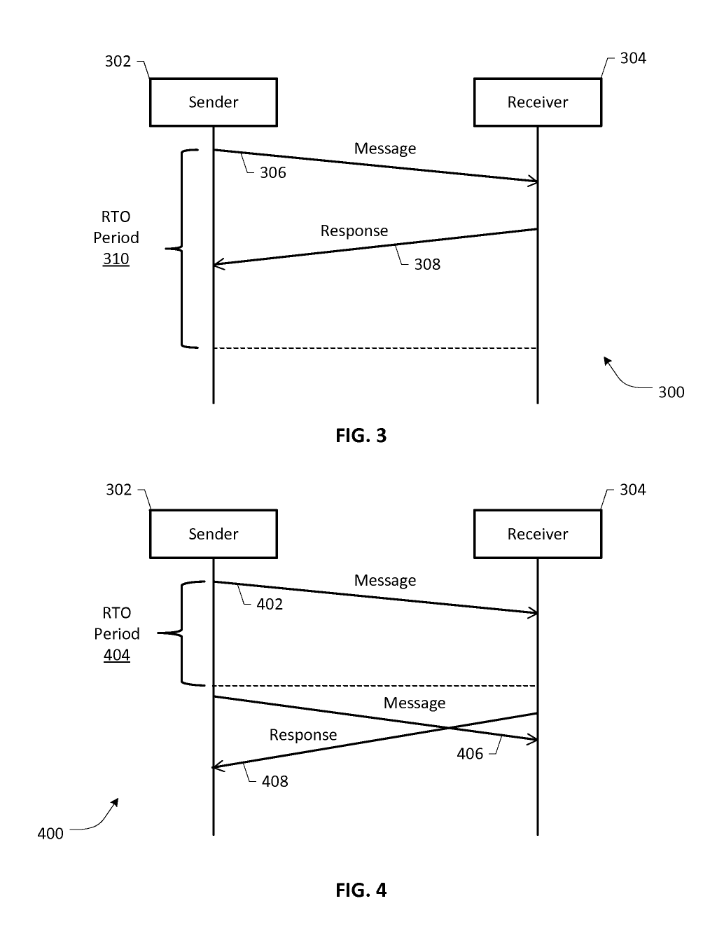

FIG. 3 depicts an example message flow diagram 300 showing an RTO period in a TCP data transmission. A message 306, e.g., control messages, data, or any other packetized information, is sent from a sender 302 to a receiver 304 over a TCP-based network connection. Sender 302 and receiver 304 can be network elements or end stations as defined above that are configured to communicate over the TCP-based network connection. Typically, when the receiver 304 receives the message 306 from the sender 302, a response 308, e.g., an acknowledgement (ACK), can be sent back to the sender 302 by the receiver 304. In the illustrated embodiment, the response 308 is received well within a selected RTO period 310.

FIG. 4 depicts an example message flow diagram 400 showing an RTO period setting that may cause a spurious retransmission of data. As before, sender 304 sends a message 402 to receiver 304. However, in this scenario, a response 408 from the receiver 304 has not been received by the sender 304 before the expiration of a selected RTO period 404. Accordingly, the expiration of the RTO period 404 prompts a spurious retransmission 406 of the message 402. Additional details regarding a TCP data transmission process and retransmission may be found in the following commonly owned U.S. patent application(s): (i) “METHOD AND APPARATUS FOR PROVIDING A TRANSMISSION CONTROL PROTOCOL MINIMUM RETRANSMISSION TIMER,” application Ser. No. 14/061,259, filed Oct. 23, 2013, published as U.S. Patent App. Publication No.: 2015/0012792; incorporated by reference hereinabove.

As one skilled in the art will recognize, there can be various causes for spurious retransmissions. One such cause can be attributed to the inability of the receiver to send an ACK to the sender because the TCP stack or protocol engine runs in a user space of the network element, e.g., receiver 304. In certain arrangements, such a user space may be executed in a thread that is not always running. When the thread is not running, a delay can be introduced in the RTT variable as measured by the sender 302 because the receiver 304 can receive a packet from sender 302 but will not be able to send a response to the sender 302. In addition, if this delay is too long, a spurious retransmission from the sender 302 to the receiver 304 will occur because an ACK has not been received from receiver 304 prior to the commencement of the RTO period.

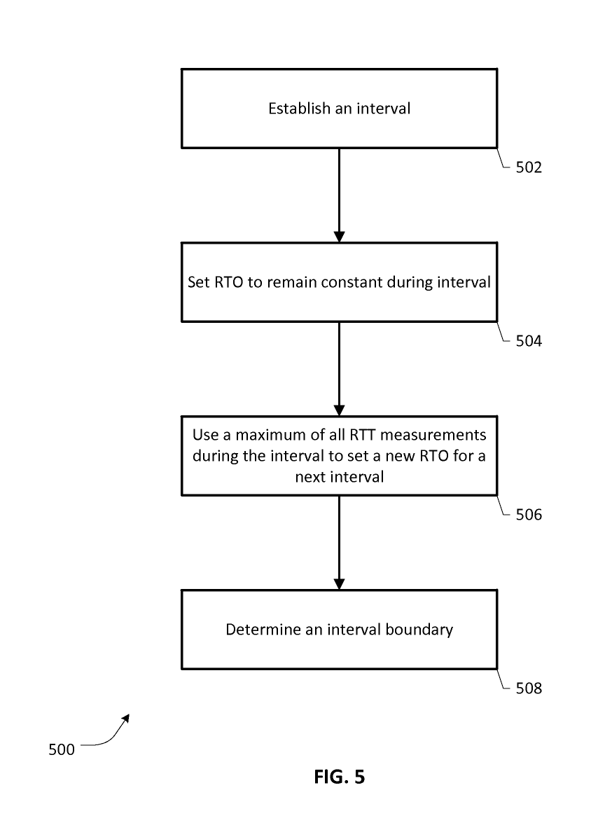

Referring now to FIG. 5, depicted therein is a method 500 for reducing spurious retransmissions in a TCP environment according to one embodiment. At block 502, an interval is established. In one embodiment, the RTO of the initial interval is set to 1 second.

In the alternative, the regular algorithm of RFC 6298 can be run during the initial interval. In one embodiment, an exponential smoothing algorithm, e.g., as defined in RFC 6298, may be used to set the RTO for the first interval. The RTTs would still be individually measured in preparation for the second, e.g., next, interval.

Accordingly, it should be appreciated that this embodiment of the present disclosure may be provided as an alternative to section 2 of RFC 6298. Further, in a particular variation, the backing-off mechanism as set forth in section 5 of RFC 6298 may remain intact.

In one embodiment, the length of the initial interval may be configured to be shorter than the subsequent intervals. In one variation, the length of the initial interval may be defined as a time period required to obtain 3 RTT measurements. In another variation, the RTO of the initial interval may be determined from a history of previous connections, including the history of RTTs on a particular connection, the type of data being transmitted, network conditions, and the like.

At block 504, the RTO is set to remain constant during the interval. At block 506, a maximum of all RTT measurements during the interval is used to set a new RTO for a next interval. In one embodiment, the RTO is set to 1.25 times the highest measured RTT in order to provide a guard band or headroom. In another embodiment, the RTO can be set using a high-biased exponential smoothing algorithm.

At block 508, an interval boundary may be determined. The interval boundary, e.g., the end of an interval or the beginning of the next interval, is determined when either of the following events occurs: (1) an RTT is measured to be higher than the RTT used to determine the RTO for the current interval; or (2) TCP has transmitted a certain amount of data into the connection (e.g., about 20 windows of data). In one embodiment, the RTO of a present interval may be set to a value of a maximum RTT of the previous interval.

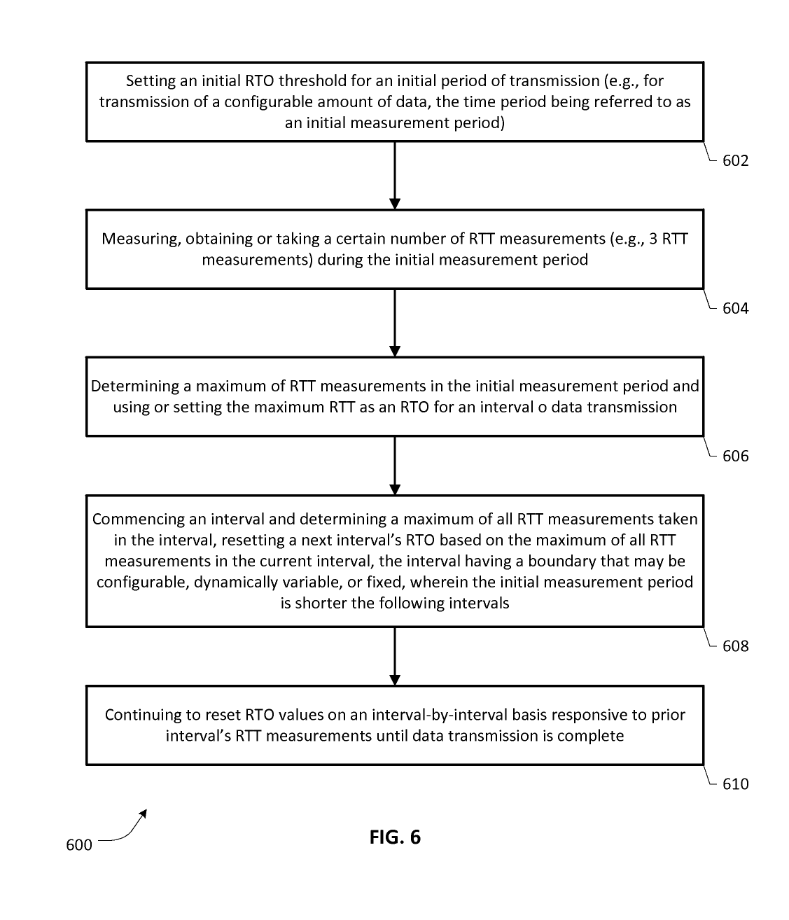

FIG. 6 depicts a flowchart of additional blocks, steps or acts that may be employed in a process 600 as a further variation of the above scheme wherein a initial measurement period is explicitly set forth for a data transmission process for obtaining a certain number of RTT measurements prior to commencing the RTO (re)adjustment mechanism on an interval-by-interval basis. At block 602, an initial RTO threshold for an initial period of transmission (e.g., for transmission of a configurable amount of data) may be set. For purposes herein, the initial time period may be referred to as an initial measurement period. At block 604, a certain number of RTT measurements may be obtained, estimated, or otherwise measured during the initial measurement period. In one embodiment, the initial measurement period may be set as a time period needed for transmitting a relatively small amount of data. In another embodiment, the initial measurement period may be defined as the time required for obtaining a select number of RTT measurements (e.g., 3 RTT measurements). Regardless of how the initial measurement period is configured, a maximum of the RTT measurements obtained in the initial measurement period is determined, which maximum RTT value is used for setting as an RTO for an interval of data transmission that commences after the initial measurement period (block 606). From this point on, a dynamic RTO (re)adjustment process can be executed similar to the embodiments set forth above. Accordingly, upon commencing an interval and determining a maximum of all RTT measurements taken in the interval, a next interval's RTO may be reset as the maximum of all RTT measurements in the current interval (block 608). Furthermore, as pointed out previously, the intervals may be provided with boundaries that may be configurable, dynamically variable, or fixed, wherein the initial measurement period may be configured to be shorter the following intervals. The RTO (re)adjustment process 600 continues to reset RTO values on an interval-by-interval basis responsive to prior K intervals' RTT measurements until data transmission is complete (block 610).

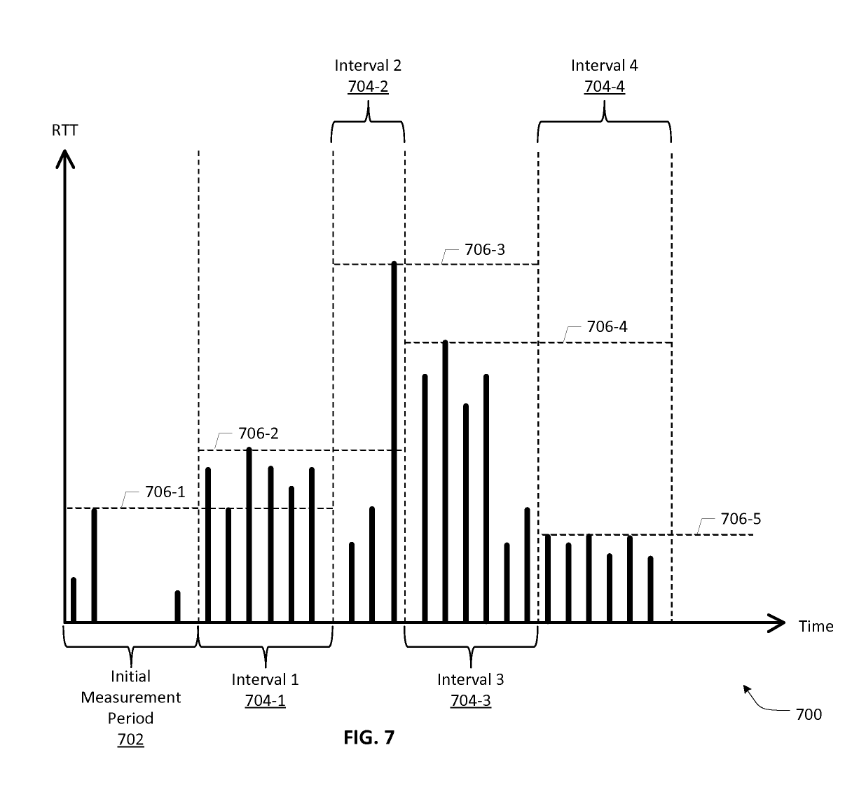

FIG. 7 illustrates a graph 700 showing RTT measurements during an initial measurement period followed by a plurality of data transmission intervals wherein an RTO threshold parameter is dynamically (re)adjusted according to one embodiment. In graph 700, RTT measurements are plotted on Y-axis against data transmission intervals plotted on X-axis. As noted previously, initial measurement period and data transmission intervals may be defined in terms of lengths of time or in terms of amounts of transmitted data (e.g., a number of packets or bytes). RTT measurements for an initial measurement period 702 are obtained, whose maximum 706-1 may be set as the RTO threshold parameter for a following interval 704-1. The boundary for the initial measurement period 702 preceding a plurality of data transmission intervals 704-1 to 704-4 may be configurably determined as set forth hereinabove. Accordingly, the interval boundary, e.g., the end of the initial measurement period or the beginning of the first interval 704-1 may occur after a certain amount of TCP data has been transmitted into the connection, e.g., the connection between nodes 104 and 110 shown in FIG. 1. As to the RTO threshold for the initial measurement period, it may be set, selected or otherwise determined using any of the techniques described in the previous sections.

Upon obtaining the maximum RTT value 706-1 from the initial measurement period 702, it is used in determining or setting the RTO threshold parameter for interval 1 704-1. As part of the dynamic RTO (re)adjustment process, a plurality of RTT measurements obtained in interval 1 704-1 are used to determine a maximum RTT value 706-2, which is used to determine the RTO period for interval 2 704-2. In interval 2, the third RTT value obtained therein is illustrated as exceeding the maximum RTT value for interval 1 (i.e., the RTO threshold 706-2 of interval 2). Accordingly, a boundary for interval 2 704-2 may be determined immediately thereafter, although the interval boundary for interval 2 as such may occur before a certain set amount of data has been transmitted into the connection. It should therefore be recognized that although a gap between the third RTT measurement and the next interval, i.e., interval 3 704-3, is shown in FIG. 7, it is purely for illustrative purposes (to highlight and demarcate a boundary). Further, the third RTT measurement in interval 2 704-2 being the maximum RTT, it is set as the RTO threshold value 706-3 for the following interval, i.e., interval 3 704-3. RTT measurements continue to be taken in interval 3 704-3. Because the maximum RTT value in interval 3 704-3 does not exceed the maximum RTT value from interval 2, the interval boundary for interval 3 704-3 occurs after a certain amount of data has been transmitted into the connection. For the following interval, i.e., interval 4 704-4, the RTO threshold parameter is (re)adjusted or (re)set as the maximum RTT value 706-4 obtained in the prior interval 3 706-3. Likewise, because the maximum RTT value in interval 4 704-4 does not exceed the maximum RTT value from interval 3 704-3, the boundary for interval 4 is based on the amount of data transmitted into the connection. The maximum RTT value 706-5 obtained in interval 4 704-4 may be used in setting the RTO threshold value for the following data transmission interval.

Based on the foregoing, it should be understood that boundary determination from interval to interval may vary and the intervals may have different lengths or comprise different amounts of transmitted data. Whereas the initial measurement period 702 may be configured to be of sufficient time (or amount of data) to obtain a select number of RTT measurements, an embodiment of the RTO adjustment process may be configured such that it is shorter than the rest of the data transmission intervals.

In a typical environment, high RTTs rather than low RTTs may cause spurious retransmits on a connection. Therefore, an embodiment of the present disclosure considers high RTT measurements in the formulation of successive RTO (re)adjustments over the course of a data transmission session or event. On the other hand, if an RTO/RTT estimator only ever used the highest measured RTT and the network conditions improve, the RTO/RTT estimator may never reduce the estimate to track the improved network conditions. However, it should be appreciated that the risk of a spurious retransmission may increase if the RTO/RTT estimator decreases its estimate. Accordingly, in one embodiment, a determination is made as to when a spurious transmission is acceptable, e.g., according to a packet retransmission rate threshold, so as to achieve a balance depending on the design objectives. In one arrangement, a maximum of a full window is retransmitted whenever a retransmission occurs, wherein a window of data is the largest ever advertised window of a session. In certain implementations, one in 20 to 50 packets can be retransmissions. Therefore, in such an embodiment, the RTO/RTT estimate may not be reduced until 20 to 50 maximum windows of data have been transmitted.

Where a delayed ACK timer is implemented in an example transport layer mechanism, such a delayed ACK timer may be accommodated within an RTO adjustment process set forth herein, i.e., it is not necessarily handled differently. For example, if a delayed ACK timer is in effect on a peer (e.g., an Rx node), it may cause high RTT measurements at the Tx node. If the delayed ACK happens less than every 20 windows, then it may be included as part of the maximum RTT measurement in an embodiment of the RTO adjustment process. If it happens after more than 20 windows of data have been transmitted, it is possible that resulting retransmission is not excessive in an example arrangement.

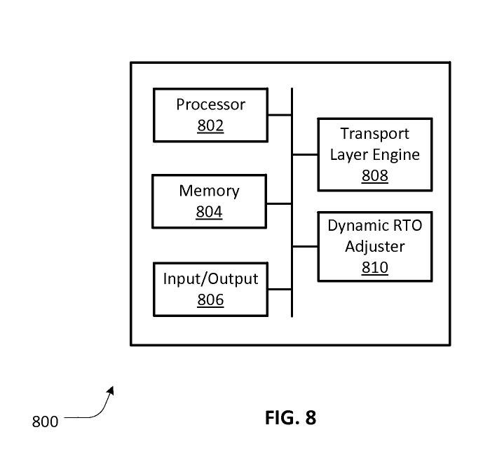

FIG. 8 depicts a block diagram of an example node 800 having a dynamic RTO adjustment mechanism according to an embodiment of the present patent disclosure. Node 800 is representative of a Layer 4 transmitting end station such as elements 100, 302 described hereinabove and comprises one or more processors (CPU) 802, one or more memory subsystems 804, e.g., random access memory (RAM) and/or read only memory (ROM), and various input/output interfaces or devices 806, (e.g., storage devices, including but not limited to, a tape drive, a floppy drive, a hard disk drive or a compact disk drive, a receiver, a transmitter, etc.). A transport layer engine 808, which may be realized in hardware, software or in combination, is configured to effectuate Layer 4 functionality in a suitable protocol stack (e.g., TCP, SCTP, etc.) with respect to data transmission on a connection with another Layer 4 node. A dynamic RTO adjuster 810 is operative in conjunction with the transport layer engine 808 under control of the processor(s) 802 executing appropriate program code or instructions for implementing one or more embodiments of a process described above so as to reduce spurious retransmissions in a transport layer environment. As noted previously, embodiments herein can be implemented directly by a physical network element or in a virtual machine running suitable Layer 4 code on a hardware platform.

The processes described above, including but not limited to those presented in connection with FIGS. 1-7, may be implemented in general, multi-purpose or single purpose processors. Such a processor, e.g., processor 802, may be configured to execute instructions, either at the assembly, compiled or machine-level, to perform that process. Such instructions can be written by one of ordinary skill in the art following the description of presented above and stored or transmitted on a computer readable medium, e.g., a non-transitory computer-readable medium. The instructions may also be created using source code or any other known computer-aided design or development tool.

One advantage of the present disclosure is that spurious retransmissions are reduced in an environment of highly variable RTT. Also, the RTT is not constrained by any minimum value. Thus, for example, if the RTT is never more than 1 millisecond, then the RTT estimator will use 1 millisecond to determine the RTO period and not the RFC 6298 mandated minimum of 1 second. It should be appreciated that embodiments of a dynamic RTO (re)adjustment mechanism set forth herein provide a more balanced configuration such that it is more representative of dynamic conditions on a connection rather than being statically set to a particular value.

In particular, it should be appreciated that virtual machine environments can create bursty environments for TCP, especially if the TCP also runs in a thread within a process of a busy host machine. In such scenarios, RTT measurements can frequently be hundreds of times an average RTT measurement. A retransmission timer (RTO) mechanism that decays even a little bit for each small measured RTT may cause a retransmission for every such outlier RTT. Accordingly, an embodiment described herein provides a retransmission timer mechanism as a compromise choice for certain implementations, wherein the RTO is not set too low (thereby reducing the probability of excessive retransmissions to occur), or too high (thereby ensuring that it does not take too long to retransmit when it is really needed). As a consequence, an embodiment of the present disclosure achieves the right balance when an acceptably small number of retransmissions occur. As the embodiments do not require a minimum value to be configured for an RTO setting, the teachings herein can be advantageously practiced in arrangements where the typical RTTs are ˜100 μS as well as in arrangements where the typical RTTs are ˜10 seconds. More broadly, in one aspect, an example embodiment of the dynamic RTO (re)configuration scheme of the present invention may be employed in a transport protocol environment that utilizes one or more prior RTT or other acknowledgement measurements or values in (re)setting an RTO threshold over a data transmission session.

In the above-description of various embodiments of the present disclosure, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and may not be interpreted in an idealized or overly formal sense expressly so defined herein.

At least some example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. Such computer program instructions may be provided to a processor circuit of a general purpose computer circuit, special purpose computer circuit, and/or other programmable data processing circuit to produce a machine, so that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s). Additionally, the computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

As alluded to previously, tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/Blu-ray). The computer program instructions may also be loaded onto or otherwise downloaded to a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

Further, in at least some additional or alternative implementations, the functions/acts described in the blocks may occur out of the order shown in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated and blocks from different flowcharts may be combined, rearranged, and/or reconfigured into additional flowcharts in any combination or subcombination. Moreover, although some of the diagrams include arrows on communication paths to show a primary direction of communication, it is to be understood that communication may occur in the opposite direction relative to the depicted arrows.

Although various embodiments have been shown and described in detail, the claims are not limited to any particular embodiment or example. None of the above Detailed Description should be read as implying that any particular component, module, element, step, act, or function is essential such that it must be included in the scope of the claims. Reference to an element in the singular is not intended to mean “one and only one” unless explicitly so stated, but rather “one or more” or “at least one”. All structural and functional equivalents to the elements of the above-described embodiments that are known to those of ordinary skill in the art are expressly incorporated herein by reference and are intended to be encompassed by the present claims. Accordingly, those skilled in the art will recognize that the exemplary embodiments described herein can be practiced with various modifications and alterations within the spirit and scope of the claims appended below.

What is claimed is:

1. A method for reducing spurious retransmissions in a Transmission Control Protocol (TCP) environment, the method comprising:
setting an initial retransmission timeout (RTO) for an initial measurement period of data transmission on a connection using TCP;
obtaining a select number of round trip time (RTT) measurements during the initial measurement period of data transmission;
determining a maximum of the select number of RTT measurements to be set as an RTO for an interval of data transmission;
during the interval, determining a maximum of all RTT measurements obtained in the interval and resetting a next interval's RTO based on the maximum of the RTT measurements; and
continuing to reset RTO values on an interval-by-interval basis responsive to RTT measurements taken in a prior interval until data transmission is complete,
wherein the intervals have a configurable boundary and the initial measurement period of data transmission is shorter than a length of the intervals following the initial measurement period.

2. The method as recited in claim 1, wherein an interval's configurable boundary is determined when an RTT measurement of the interval is measured to be greater than a maximum RTT measured in the prior interval, which maximum is used to set an RTO for the interval.

3. The method as recited in claim 1, wherein an interval's configurable boundary is determined when a select amount of data has been transmitted into the connection.

4. The method as recited in claim 1, wherein an interval's configurable boundary is defined as an end of the interval or a beginning of the next interval.

5. The method as recited in claim 1, wherein the TCP is run on a physical network element.

6. The method as recited in claim 1, wherein the TCP is run on a virtual machine (VM) environment.

7. The method as recited in claim 1, wherein a next interval's RTO is reset as the maximum of the RTT measurements taken in the prior interval in addition to a configurable guard band comprising a select percentage of the prior interval's maximum RTT measurement.

8. The method as recited in claim 1, wherein the initial measurement period is configured to be at least three RTT measurements.

9. The method as recited in claim 1, wherein the initial RTO for the initial measurement period is set based on a history of RTOs associated with the connection.

10. The method as recited in claim 1, further comprising determining when a spurious transmission is acceptable.

11. The method as recited in claim 10, wherein the acceptability of the spurious retransmission is determined according to a packet retransmission rate threshold.

12. A method for dynamically configuring a retransmission timeout (RTO) parameter for a transport protocol in a network element, the method comprising:
in an interval of data transmission, determining an RTO threshold for a next interval based on a plurality of transmission acknowledgement times returned from a receiver in the interval; and
successively adjusting RTO thresholds for subsequent intervals based on a previous interval's measurements of transmission acknowledgement times until the data transmission is completed.

13. The method as recited in claim 12, wherein the data transmission is effectuated according to one of a Transmission Control Protocol (TCP) and Stream Control Transport Protocol (SCTP).

14. The method as recited in claim 13, wherein an RTO threshold for an initial period of data transmission, prior to commencing determining RTO thresholds based on previous interval's measurements, is preconfigured.

15. An apparatus for reducing spurious retransmissions in a Transmission Control Protocol (TCP) environment, the apparatus comprising:
a processor configured to:
set an initial retransmission timeout (RTO) for an initial measurement period of data transmission on a connection using TCP;
obtain a select number of round trip time (RTT) measurements during the initial measurement period of data transmission;
determine a maximum of the select number of RTT measurements to be set as an RTO for an interval of data transmission;
during the interval, determine a maximum of all RTT measurements obtained in the interval and reset a next interval's RTO based on the maximum of the RTT measurements; and
continue to reset RTO values on an interval-by-interval basis responsive to RTT measurements taken in a prior interval until data transmission is complete,
wherein the intervals have a configurable boundary and the initial measurement period of data transmission is shorter than a length of the intervals following the initial measurement period.

16. The apparatus as recited in claim 15, wherein an interval's configurable boundary is determined when an RTT measurement of the interval is measured to be greater than a maximum RTT measured in the prior interval, which maximum is used to set an RTO for the interval.

17. The apparatus as recited in claim 15, wherein an interval's configurable boundary is determined when a select amount of data has been transmitted into the connection.

18. The apparatus as recited in claim 15, wherein an interval's configurable boundary is defined as an end of the interval or a beginning of the next interval.

19. The apparatus as recited in claim 15, wherein the TCP is run on a physical network element.

20. The apparatus as recited in claim 15, wherein the TCP is run on a virtual machine (VM) environment.

21. The apparatus as recited in claim 15, wherein a next interval's RTO is reset as the maximum of the RTT measurements taken in the prior interval in addition to a configurable guard band comprising a select percentage of the prior interval's maximum RTT measurement.

22. The apparatus as recited in claim 15, wherein the initial measurement period is configured to be at least three RTT measurements.

23. The apparatus as recited in claim 15, wherein the initial RTO for the initial measurement period is set based on a history of RTOs associated with the connection.

24. The apparatus as recited in claim 15, wherein the processor is further configured to determine when a spurious transmission is acceptable.

25. The apparatus as recited in claim 24, wherein the acceptability of the spurious retransmission is determined according to a packet retransmission rate threshold.
